(19) United States
(12) Patent Application Publication
(10) Pub. No.: US 2006/0147256 A1
(43) Pub. Date: Jul. 6, 2006

(54) SELECTIVELY ROTATABLE TOOL CONNECTOR

(75) Inventors: William Daniel Richardson, Greenwood, MO (US); Dwight Poole, Harrisonville, MO (US)

Correspondence Address: HOVEY WILLIAMS LLP, 2405 GRAND BLVD., SUITE 400, KANSAS CITY, MO, 64108, US

(73) Assignee: SPECIALTY PRODUCTS OF GREENWOOD, MISSOURI, INC., Greenwood, MO (US)

(21) Appl. No.: 10/905,390

(22) Filed: Dec. 30, 2004

(51) Int. Cl. F16C 11/00

(52) U.S. Cl. 403/91

(57) ABSTRACT

A rotationally adjustable handle and working tool assembly (10) is provided having an elongated handle (12) presenting a tool-supporting end (22), a working tool (14), and a connector (16) permitting tool adjustment. The connector (16) includes a coupler (32) adapted for connection to the end (22) of handle (12), an adjacent tool mount (34) and a spring assembly (36). Preferably, the coupler (32) is permanently connected to the tool end (22) and has locking splines (48); the tool mount (34) is equipped with a tool-supporting element (60) and locking splines (58) complemental with the coupler splines (48). The tool mount (34) is shiftable against the bias of spring assembly (36) to allow the user to selectively rotate and securely locate the tool (14) relative to handle (12).

### BACKGROUND OF THE INVENTION

1. Field of the Invention

The present invention is broadly concerned with improved handle and working tool assemblies generally including an elongated handle and a working tool. More particularly, the present invention concerns a connector that permits selective rotational adjustment of the tool relative to the handle so as to allow the user to precisely position the tool for optimum functionality.

2. Description of the Prior Art

Working tools such as paint applicators, light bulb changers and cleaning devices are typically provided with handles of varying length to facilitate their use. In some instances use is made of relatively long handle extensions giving the user an extended reach. See, for example, U.S. Pat. Nos. 4,993,101, 5,148,723, 5,220,707, 5,316,264, 5,460,458, 5,579,558, 5,692,856, 5,682,641, 5,743,577, 6,349,451, 6,453,777, 6,530,124, 6,532,630, 6,553,628, 5,385,420, D331,650, D354,554, and D452,777. Some of these prior handle extensions are equipped with releasable locking devices for attachment of tools and/or are of telescopic design for axial adjustment.

Notwithstanding the widespread use of working tools and handles of various types, a problem may be presented because of the position of a working tool relative to the supporting handle. For example, some extension handles are equipped with an arcuate outermost end, which facilitates application of paint when using a roller or brush. However, if a paint applicator tool is secured to the upper end of such a pole in a skewed relationship relative to the upper curved end of the extension, use of the tool can be rendered very difficult or even impossible. This is a distinct possibility where there is a threaded connection between the paint applicator tool and the handle. On the one hand it is necessary to securely tighten the tool via the threading so as to prevent inadvertent detachment of the tool during use. On the other hand, such tightening may improperly orient the tool for efficient use.

### SUMMARY OF THE INVENTION

The present invention overcomes the problems outlined above and provides an improved connector for coupling a handle end with a working tool while allowing selective rotational adjustment of the tool. Broadly speaking, the connector includes a coupler adapted for connection to the handle end and having a first locking component, together with a tool mount adjacent the coupler and having a second locking component and an attachment element permitting attachment of a working tool thereto. The connector also comprises a spring mechanism biasing the first and second locking components of the coupler and tool mount into secure locking engagement to prevent rotation of the working tool relative to the handle. However, the tool mount is shiftable against the bias of the spring mechanism in order to allow rotational adjustment of the tool relative to the handle between a number of different rotational positions, where the first and second locking components serve to lock the working tool relative to the handle at the different rotational positions under the influence of the bias of the spring mechanism.

Another aspect of the present invention involves a handle assembly for use with a working tool. The handle assembly includes an elongated handle presenting a tool-supporting end, as well as a connector for coupling the tool to the tool-supporting end of said handle. The connector including a coupler, a tool mount, and a spring mechanism. The coupler is attached to the tool-supporting end and includes a first locking component. The tool mount is adjacent the coupler and includes a second locking component and a tool attachment element adapted for attachment to the working tool. The spring mechanism biases the first and second locking components into locking engagement to prevent rotation of said tool mount relative to said handle. The mount is shiftable against the bias of the spring mechanism in order to allow rotational adjustment thereof relative to the handle between a number of different rotational positions. The first and second locking components serve to lock the mount relative to the handle at the different rotational positions under the influence of the bias of the spring mechanism.

Yet a further aspect of the present invention involves a handle and working tool assembly. The assembly includes an elongated handle presenting a tool-supporting end, a working tool, and a connector for coupling the tool to the tool-supporting end of the handle. The connector includes a coupler, a tool mount, and a spring mechanism. The coupler is attached to the tool-supporting end and includes a first locking component. The tool mount is adjacent the coupler and includes a second locking component and an attachment element. The working tool is attached to the element. The spring mechanism biases the first and second locking components into locking engagement to prevent rotation of the working tool relative to the handle. The mount is shiftable against the bias of the spring mechanism in order to allow rotational adjustment of the tool relative to the handle between a number of different rotational positions. The first and second locking components serve to lock the working tool relative to the handle at the different rotational positions under the influence of the bias of the spring mechanism.

In preferred forms, the coupler is permanently affixed to the end of a supporting handle and presents a socket and a plurality of radially spaced apart splines. The tool mount includes a shank shiftable within the socket of the coupler and also has splines complemental with those of the coupler. The spring is supported on an elongated rod extending through aligned bores provided in the coupler rand tool mount, so as to provide the necessary locking bias.

Adjustment of the tool relative to the handle can be readily accomplished by shifting the tool mount against the spring bias, in order to separate the mated locking splines. At this point the user may rotationally adjust the tool as desired, whereupon the tool mount is moved back to the locked position thereof under the influence of the spring bias.

Other aspects and advantages of the present invention will be apparent from the following detailed description of the preferred embodiments and the accompanying drawing figures.

### BRIEF DESCRIPTION OF THE DRAWINGS

Preferred embodiments of the invention are described in detail below with reference to the attached drawing figures, wherein:

FIG. 1 is a perspective view of a handle and working tool assembly in accordance with the invention, shown during rotational adjustment of the tool;

FIG. 2 is a perspective view similar to that of FIG. 1, but depicting the tool as rotationally adjusted and locked in place;

FIG. 3 is a fragmentary exploded view illustrating the components of the preferred connector used for interconnecting the handle and working tool;

FIG. 4 is an exploded perspective view of the connector;

FIG. 5 is a plan view of the coupler forming a part of the connector;

FIG. 6 is an enlarged, fragmentary view in partial vertical section illustrating the connector during rotational adjustment; and

FIG. 7 is an enlarged, fragmentary view similar to that of FIG. 6, but depicting the connector in its locked position.

### DETAILED DESCRIPTION OF THE PREFERRED EMBODIMENT

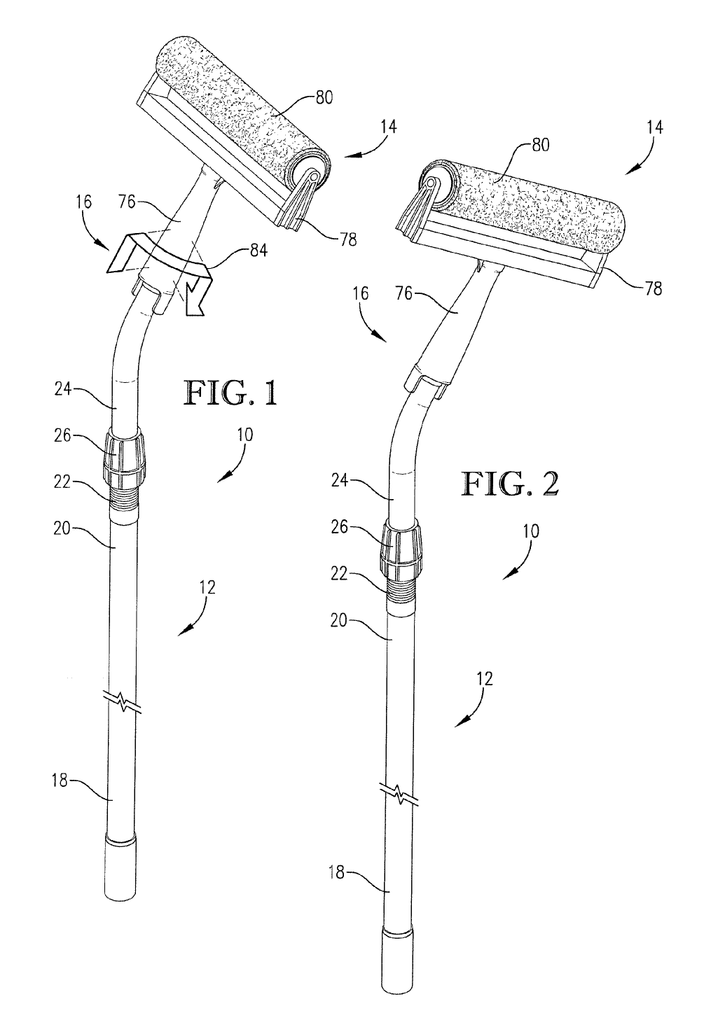

Turning now to the drawings, a handle and working tool assembly 10 is depicted in FIGS. 1-3 and broadly includes an elongated handle 12, a working tool 14, and a connector 16 serving to operably interconnect the handle 12 and tool 14. The handle 12 and connector 16 are preferably provided as a single assembly for use with any one of a number of different types of working tools. The connector 16 serves to firmly lock the tool 14 in place relative to the handle 12, and also permits selective rotational adjustment of the tool between any one of a number of different rotational positions. In this way, the user may manipulate the tool 14 in order to locate it in an optimum orientation relative to the handle 12.

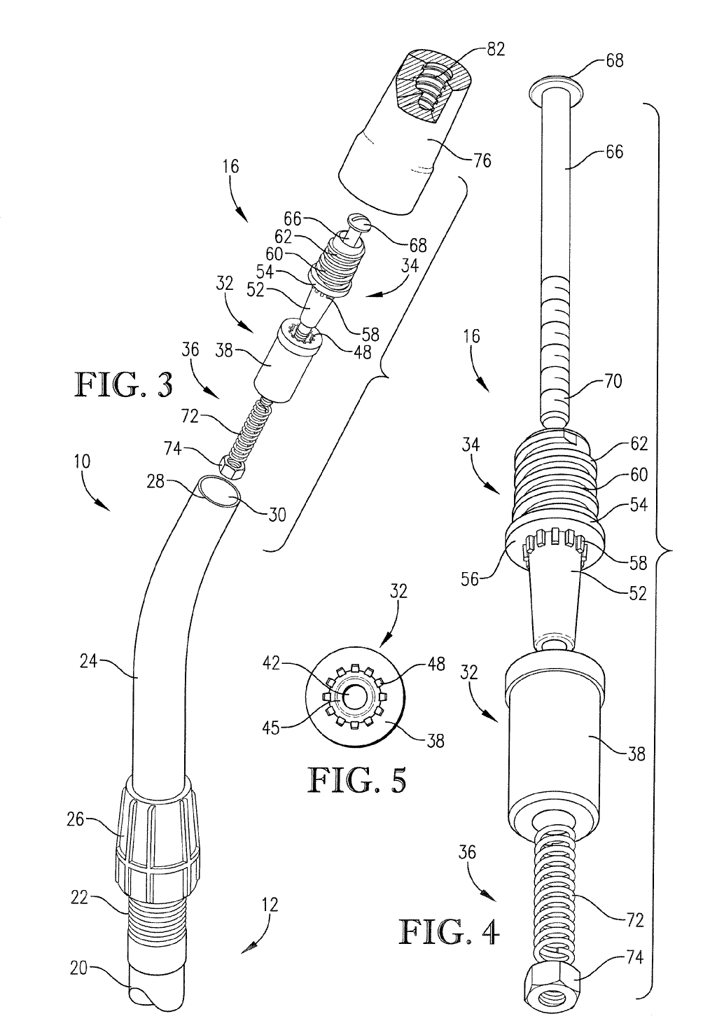

In more detail, the handle 12 in the form shown is an elongated tubular extension handle 18 presenting a main body 20 having a threaded upper end 22. The overall handle 12 further includes an arcuate, upper, tool-supporting section 24 which is slidably received in main body 20 to permit telescopic adjustment of the length of the handle 12. In the illustrated embodiment, a chuck and collet locking mechanism 26 is provided for securing the section 24 at the adjusted position relative to the body 20, although the principles of the present invention are equally applicable to other suitable locking mechanisms. As best seen in FIGS. 3 and 6-7, the section 24 presents an open uppermost end 28 defining an axially extending opening 30. While an extension handle of this type is depicted in the drawings, it will be understood that the invention is not so limited; that is, handles of various configurations, lengths, or shapes (e.g., straight handles or handles with non-circular cross-sectional shapes), including simple unitary handles or multiple-section extension handles, can be employed.

The connector 16 broadly includes a coupler 32, tool mount 34 and spring assembly 36. In the form shown, the coupler 32 is permanently secured within opening 30 whereas tool mount 34 is shiftable relative thereto. The spring assembly 36 serves to bias the coupler and mount together, while permitting rotational adjustment of the latter as described below.

The preferred coupler 32 is in the form of an elongated tubular body 38 staked or otherwise permanently secured within opening 30. The body 38 presents an uppermost socket 40, a central bore 42 and a lowermost, radially expanded bore 44. In this fashion, upper and lower shoulder 45, 46 are defined on opposite ends of bore 42. The uppermost end of body 38 has a series of radially extending, circumferentially spaced apart male splines 48 (see FIGS. 3 and 6-7) located about and defining the upper periphery of socket 40. Furthermore, the socket 40 tapers toward the bore 42 for purposes which will be described hereinbelow.

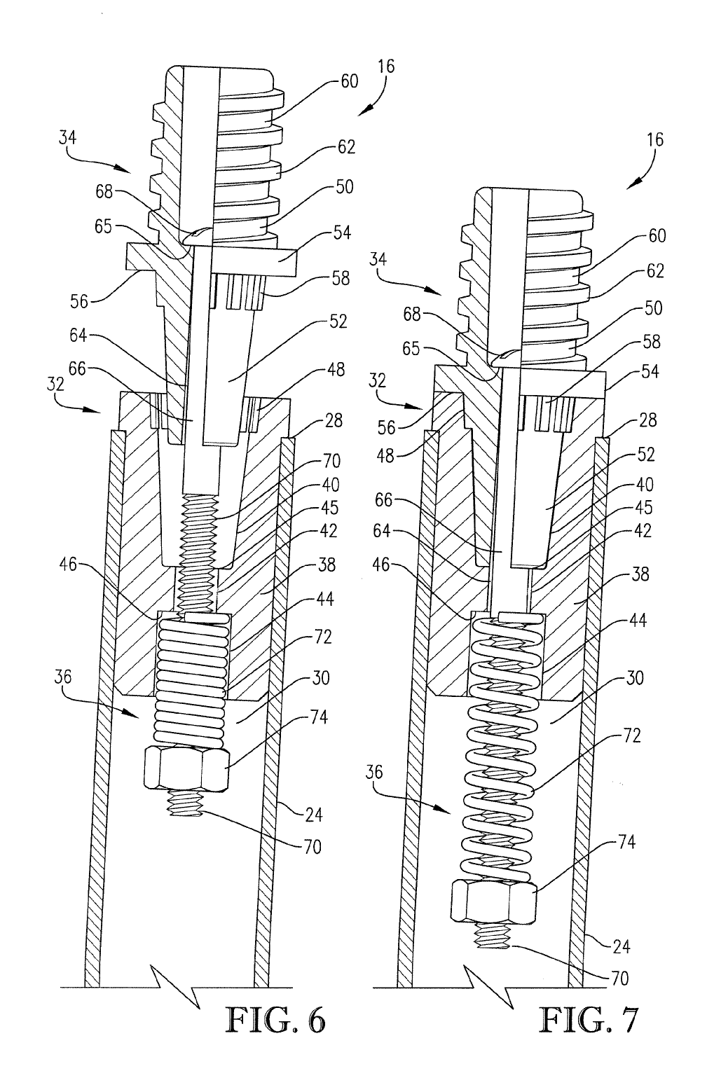

The tool mount 34 is an elongated, tubular body 50 having a lowermost shank 52 slidably located within socket 40. The body 50 also has a radially enlarged stop ring 54 midway along the length thereof, presenting an underside 56 adapted to engage the upper butt end of body 38. The shank 52 tapers away from the ring 54 to present a shape corresponding to that of the socket 40, whereby the shank 52 is snugly received within the socket 40. A series of radially extending, circumferentially spaced apart male splines 58 are defined about the shank 52 adjacent the underside 56 of the stop ring 54. The splines 58 are configured for complemental tool-locking interengagement with female splines 48. The illustrated coupler 32 and tool mount 34 are provided with twelve (12) complementary splines to afford the same number of positions for the tool 14 relative to the handle 12; however, it is within the ambit of the present invention to utilize alternative arrangements that provide more or less tools positions relative to the handle. The overall body 50 further includes an upwardly extending tool attachment element 60 having threading 62. As best seen in FIGS. 6-7, the body 50 has an elongated central through bore 64 extending the full length thereof and in axial alignment with the socket 40 and bores 42, 44 of body 38. The bore 64 has an enlarged upper end defining a recess and an annular shoulder 65.

Those of ordinary skill in the art will appreciate that the principles of the present invention are equally applicable to other interlocking arrangements between the coupler and tool mount. For example, rather than complemental splines, the coupler and tool mount could include a complemental polygonal-shaped male and female connection. The coupler and tool connector could alternatively include a locking pin that is inserted in aligned openings once the tool 14 is appropriately positioned relative to the handle 12.

The spring assembly 36 includes an elongated bolt 66 having an upper head 68 and a shank with a lowermost threaded end 70. The head 68 abuts shoulder 65, and the shank of bolt 66 extends through bore 64, socket 40 and bores 42, 44, terminating below the lower end of body 38. The assembly 36 also has a coil spring 72 telescoped over the lower threaded end of bolt 66, and a nut 74 threaded onto end 72 in order to captively retain the spring 72 between shoulder 46 and the nut 74. The principles of the present invention are also applicable to various other spring mechanisms. For example, the coil spring 72 can alternatively be retained on a non-threaded rod (not shown) by suitable a fastener or retainer (e.g., a cotter pin).

In the embodiment illustrated, the tool 14 is a paint roller including a connection handle 76, a yoke 78 and paint roller 80 and may be the type described in U.S. Pat. No. 6,681,438. The handle 76 is internally threaded as at 82 (see FIG. 3) so that the handle may be threaded onto threading 62 of element 60. It will of course be understood that a variety of working tools can be used in this context (e.g., paint brushes or pads, light bulb changers, or cleaning brushes), and that the depicted paint roller is merely an example of one such tool. Additionally, the illustrated embodiment makes use of a threaded interconnection between handle 76 and element 60, but other connection hardware could be used in lieu of threading.

In the use of the assembly 10, a tool 14 is first secured to the attachment element 62 in the usual fashion. In the embodiment shown, this involves merely threading the handle 76 onto threading 62 of attachment element 60 until tight. If the user then wishes to change the rotational position of the tool 14 relative to handle 12, it is only necessary to grasp handle 76 and pull it upwardly as shown in FIG. 6, against the bias of spring 72. This axially shifts the tool mount 34 relative to coupler 32, thus separating the splines 48 and 58. The user may then rotationally shift the handle 76 about the axis of bolt 66 until the tool is properly positioned; this is illustrated in FIG. 1, where the rotational movement is illustrated by arrow 84. Thereupon, the user allows the handle 76 to be pulled back into its locked position under the influence of spring 72, until the mount 34 bottoms out against shoulder 45 within socket 40 of coupler 32, thus reestablishing the locking interengagement between the splines 48 and 58 to hold the tool 14 firmly in place.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A tool connector for coupling a working tool with a handle, said connector comprising:
a coupler adapted for connection to said handle and including a first locking component;
a tool mount adjacent said coupler and including a second locking component and an attachment element permitting attachment of the working tool thereto; and
a spring mechanism biasing said first and second locking components into locking engagement to prevent rotation of the working tool relative to the handle,
said mount shiftable against the bias of said spring mechanism in order to allow rotational adjustment of the tool relative to the handle between a number of different rotational positions, said first and second locking components serving to lock the working tool relative to the handle at said different rotational positions under the influence of the bias of said spring mechanism.

2. The tool connector of claim 1,
said coupler being permanently affixed to said handle end.

3. The tool connector of claim 2,
said coupler comprising a body located at least partially within an axially extending opening of the handle.

4. The tool connector of claim 1,
said coupler presenting a socket, said tool mount including a shank at least partially received within said socket.

5. The tool connector of claim 1,
said first locking component comprising a plurality of radially spaced apart first splines,
said second locking component comprising a number of complemental, radially spaced apart second splines,
said first and second splines being interengageable.

6. The tool connector of claim 1,
said attachment element comprising a threaded body.

7. The tool connector of claim 1,
said coupler and mount having aligned bores therethrough,
said spring mechanism including an elongated rod extending through said aligned bores, with a coil spring adjacent the lower end of said rod and engaging the end of said coupler remote from said mount.

8. The tool connector of claim 7,
said rod having a threaded lowermost end,
said spring being captively retained on said rod by a nut threaded onto said rod lowermost end.

9. A handle assembly for use with a working tool, said handle assembly comprising:
an elongated handle presenting a tool-supporting end; and
a connector for coupling the tool to said tool-supporting end of said handle, said connector including-
a coupler attached to said tool-supporting end and including a first locking component, and
a tool mount adjacent said coupler and including a second locking component and a tool attachment element adapted for attachment to the working tool,
a spring mechanism biasing said first and second locking components into locking engagement to prevent rotation of said tool mount relative to said handle,
said mount shiftable against the bias of said spring mechanism in order to allow rotational adjustment thereof relative to said handle between a number of different rotational positions, said first and second locking components serving to lock said mount relative to said handle at said different rotational positions under the influence of the bias of said spring mechanism.

10. The assembly of claim 9,
said coupler being permanently affixed to said tool-supporting end.

11. The assembly of claim 10,
said tool-supporting end presenting an axially extending opening,
said coupler comprising a body located at least partially within said opening.

12. The assembly of claim 9,
said coupler presenting a socket, said tool mount including a shank at least partially received within said socket.

13. The assembly of claim 9,
said first locking component comprising a plurality of radially spaced apart first splines,
said second locking component comprising a number of complemental, radially spaced apart second splines,
said first and second splines being interengageable.

14. The assembly of claim 9,
said attachment element comprising a threaded body.

15. The assembly of claim 9,
said coupler and mount having aligned bores therethrough,
said spring mechanism including an elongated rod extending through said aligned bores, with a coil spring adjacent the lower end of said rod and engaging the end of said coupler remote from said mount.

16. The assembly of claim 15,
said rod having a threaded lowermost end,
said spring being captively retained on said rod by a nut threaded onto said rod lowermost end.

17. The assembly of claim 9,
said handle comprising a telescopically adjustable extension handle.

18. The assembly of claim 17,
said tool-supporting end being curved.

19. A handle and working tool assembly comprising:
an elongated handle presenting a tool-supporting end;
a working tool; and
a connector for coupling said tool to said tool-supporting end of said handle, said connector including-
a coupler attached to said tool-supporting end and including a first locking component, and
a tool mount adjacent said coupler and including a second locking component and an attachment element, said working tool attached to said element,
a spring mechanism biasing said first and second locking components into locking engagement to prevent rotation of said working tool relative to said handle,
said mount shiftable against the bias of said spring mechanism in order to allow rotational adjustment of said tool relative to said handle between a number of different rotational positions, said first and second locking components serving to lock said working tool relative to said handle at said different rotational positions under the influence of the bias of said spring mechanism.

20. The assembly of claim 19,
said coupler being permanently affixed to said tool-supporting end.

21. The assembly of claim 20,
said tool-supporting end presenting an axially extending opening, said coupler comprising a body located at least partially within said opening.

22. The assembly of claim 19,
said coupler presenting a socket, said tool mount including a shank at least partially received within said socket.

23. The assembly of claim 19,
said first locking component comprising a plurality of radially spaced apart first splines,
said second locking component comprising a number of complemental, radially spaced apart second splines,
said first and second splines being interengageable.

24. The assembly of claim 19,
said attachment element comprising a threaded body, said tool being complementally threaded.

25. The assembly of claim 19,
said coupler and mount having aligned bores therethrough,
said spring mechanism including an elongated rod extending through said aligned bores, with a coil spring adjacent the lower end of said rod and engaging the end of said coupler remote from said mount.

26. The assembly of claim 25,
said rod having a threaded lowermost end,
said spring being captively retained on said rod by a nut threaded onto said rod lowermost end.

27. The assembly of claim 19,
said handle comprising a telescopically adjustable extension handle.

28. The assembly of claim 27,
said tool-supporting end being curved.

29. The assembly of claim 19,
said tool comprising a paint roller.
